(19) United States
(12) Patent Application Publication
(10) Pub. No.: US 2018/0278085 A1
(43) Pub. Date: Sep. 27, 2018

(54) Solar Charge Circuit and Method

(71) Applicant: Stephen Katsaros, Denver, CO (US)

(72) Inventors: Stephen Katsaros, Denver, CO (US); Steve Dunbar, Lafayette, CO (US)

(21) Appl. No.: 15/763,842

(22) PCT Filed: Sep. 27, 2016
(86) PCT No.: PCT/IB2016/055764

§ 371 Date: Mar. 28, 2018

Related U.S. Application Data
(60) Provisional application No. 62/234,647, filed on Sep. 29, 2015.

(51) Int. Cl. H02J 7/35; H02J 7/00; F21S 9/03

(52) U.S. Cl. CPC H02J 7/355; H05B 33/0815; F21S 9/037; H02J 7/0068

(57) ABSTRACT

One embodiment is a solar charged device. The solar charged device includes a housing defining an interior and an exterior; a solar panel, defining a solar panel voltage, for generating power connected to the housing exterior, the solar panel comprising a pair of terminals; a switch located in the housing interior attached to one of the solar panel terminals; a battery, defining a battery voltage, for storing the power, the battery comprising a pair of leads, one of the battery leads attached to the solar panel and one of the battery leads attached to the switch; an active charge circuit located in the housing interior operatively connected to the switch and selectively connecting the battery to the solar panel in response to the battery voltage and the solar panel voltage; and an electronic device connected to the battery for utilizing the power.

### FILED OF THE INVENTION

The present invention generally relates to solar devices. More particularly, the present invention relates to solar light with improved system efficiency by incorporation of solar charge circuits, as well as the method thereof.

### BACKGROUND

Solar panels are complicated yet life enhancing devices. In order to take energy from the sun and convert it into power that can be used or stored takes a lot of technology. One application for solar panels is to charge batteries and subsequently use the battery's energy (for example, as in a solar lights such as the one illustrated in FIG. 1). With Reference to FIG. 1, a solar light 100 may come in the form of garden walkway lights in developed countries (e.g. United States) or a solar light bulb. In its simplest form, the solar panel 104 converts solar energy into electricity that is stored in a battery (not shown), and the electricity is subsequently converted back into light when a user pushes an on/off button 106. Traditionally, a solar light 100 has 4 individual photovoltaic cells 102 assembled into a solar panel 104. This is a very important point, traditional solar lamps have an excessive number of photovoltaic cells 102—a configuration that wastes energy, increases the required size of the solar light 100, increases production fallout, and increases the cost.

FIG. 2 shows a simplified circuit diagram 110 of a typical solar light 100. The photovoltaic cells 102 typically produce 0.5 volts per cell. Therefore, individual cell 112 produces about 0.5 volts when subjected to standard sun (1000 W/m̂2) and individual cells 114, 116, and 118 operate in a similar manner. These individual cells 112, 114, 116, 118 can be wired in series to produce a higher voltage, such as the illustrated 2.0 volts for solar panel 104 referred to herein as panel voltage, V-PANEL. As previously described, power produced by the solar panel 104 is stored in a battery 120. If the solar panel 104 was always in full sun and producing constant voltage, the battery 120 and the solar panel 104 could be wired directly to each other. However, in reality clouds pass over the sun; items block individual cells (e.g. individual cell 112); temperatures shift; and sunset brings periods of low voltage—often zero volts such as in full darkness. If the battery 120 is connected directly to the solar panel 104, energy stored in the battery 120 would flow back into the solar panel 104. The photovoltaic cells 102 would act like small heating elements to consume the energy until the battery 120 depletes all of its stored energy. This condition is referred to in the industry as ‘dark current.’

With continued reference to FIG. 2, the industry has utilized (in huge numbers) a device for limiting energy to flow substantially to the battery 120 and not to the solar panel 104. This device is traditionally a barrier diode 130, more specifically a SCHOTTKY barrier diode. While this benefit generally protects the traditional solar light 100 with a low cost, it does come with tradeoffs. Specifically, the barrier diode 130 is temperature dependent, is subject to failure, and has a voltage drop across is input and output. The temperature dependency introduces unpredictability into the system, and when the solar light 100 is in strong sun during the heat of day, it is difficult to be accurate with the system design as the physical properties vary. Regarding the failure of barrier diodes such as barrier diode 130, it is known in industry that barrier diodes can be used in the assembly of solar panels—however, these barrier diodes have huge failure rates over the lifespan of solar panels. In general, it is best to avoid using these components to improve lifespan. The most troubling issue with barrier diodes such as the illustrated barrier diode 130 is voltage drop across the diode, V-DIODE.

The voltage drop V-DIODE across the barrier diode 130 requires that at least one of the photovoltaic cells 102 be used. Commercially deployed barrier diodes, such as the BAT54 from Diodes Incorporated, have a forward voltage of 800 mV at 100 mA of current. Therefore, power is lost at this barrier diode 130. When space is limited and price is critical, power loss across the barrier diode is a substantial issue because only, for example, 3 of 4 individual cells (e.g. 112, 114, 116, 118) are presenting useful power because 800 mV is ‘wasted’ by the barrier diode 130.

### SUMMARY

In one example embodiment, a solar charged device may include: a housing defining an interior and an exterior; a solar panel, defining a solar panel voltage, for generating power connected to the housing exterior, the solar panel including a pair of terminals; a switch located in the housing interior attached to one of the solar panel terminals; a battery, defining a battery voltage, for storing the power, the battery including a pair of leads, one of the battery leads attached to the solar panel and one of the battery leads attached to the switch; an active charge circuit located in the housing interior operatively connected to the switch and selectively connecting the battery to the solar panel in response to the battery voltage and the solar panel voltage; and, an electronic device connected to the battery for utilizing the power.

In another example embodiment, a solar charged device may include: a housing defining an interior and an exterior; a solar panel, defining a solar panel voltage, for generating power connected to the housing exterior: a battery, defining a battery voltage, for storing the power; a microcontroller including: a temperature sensor; and, firmware that acts on the temperature sensor to block power transfer to the battery based on temperature for protecting the battery.

In another example embodiment, a solar charged device may include: a housing defining an interior and an exterior; a solar panel, defining a solar panel voltage, for generating power connected to the housing exterior; a battery, defining a battery voltage, for storing the power; a microcontroller including: a basic clock system for tracking passage of time; and, firmware including: instructions to monitor passage of time with the basic clock system; and, instruction to track runtime of the solar light from inception of the solar charged device; a light emitting device, engaged to the battery, for providing light; a reporting condition wherein the total-time comprises a plurality of sequential idle-off and powered-on conditions of the light emitting device; wherein the total-time is represented as a series of flashes by the light emitting device; and, wherein the reporting condition comprises sequential idle-off and powered-on conditions according to the International Morse Code.

In another example embodiment, a solar charged device may include: a solar array at a solar array voltage; a battery, at a battery voltage, electrically coupled to the solar array, the battery having an upper threshold voltage; a microcontroller sensingly connected to the battery; a light emitting device providing light engaged to the battery, and having an idle-off condition and a powered-on condition; a first condition wherein the battery voltage is below the battery upper threshold voltage and the light emitting device is in the idle-off condition; and, a second condition wherein the battery threshold is above the battery upper threshold voltage and the light emitting device is in the powered-on condition.

In another example embodiment, a solar charged device may include: a solar panel including: a positive terminal; and, a ground terminal, defining a panel voltage across the terminals; an actively controlled charge circuit including: an positive input connected to the solar panel positive terminal; a ground input connected to the solar panel ground terminal; a first resistor connected across the positive input and the ground input; a microcontroller including a first input and a second input; a second resistor connected across the ground input and the microcontroller first input; a transistor including a drain, a gate, and a source; wherein the transistor drain is connected to the ground input; wherein the gate is connected to the microcontroller second input; a third resistor connected across the transistor source and the microcontroller second input; a positive battery terminal connected to the positive input; and, a ground battery terminal connected to the transistor source; wherein the positive input is connected to the positive terminal; a battery defining a battery voltage, the battery including: a positive lead connected to the actively controlled charge circuit positive battery terminal; and, a negative lead connected to the actively controlled charge circuit negative battery terminal; a device including: a positive terminal connected to the battery positive lead; a ground terminal connected to the battery ground lead; and, a power utilizing device operatively connected to the device positive and ground terminals; a first condition wherein the panel voltage is greater than the battery voltage and the transistor connects the solar panel ground terminal to the battery negative lead via the microcontroller second input, thereby transferring energy from the solar panel to the battery; and, a second condition wherein the panel voltage is less than the battery voltage and the transistor detaches the solar panel ground terminal from the battery negative lead via the microcontroller second input, thereby prohibiting the transfer of energy from the battery to the solar panel.

In an example embodiment, a method for charging a battery in a solar light may include: providing the solar charged device including: a solar panel having a pair of terminals and defining a solar panel voltage; a battery having a first terminal and a second terminal, the first terminal connected to the solar panel, the battery defining a battery voltage; a switch operably associated with the solar panel voltage and the battery voltage, the switch attached between the solar panel and the second terminal of battery; monitoring the solar panel voltage and the battery voltage; upon presence of the solar panel voltage, closing the switch; and, after the closing, charging the battery with the solar panel.

### BRIEF DESCRIPTION OF THE DRAWING

The accompanying figures of the drawing, which are incorporated in and form a part of the specification, illustrate example implementations of the present invention, but not the only ways the invention can be implemented, and together with the written description and claims, serve to explain the principles of the invention. In the drawings:

FIG. 1 illustrates a solar light bulb configured with prior art solar panel to accommodate for voltage power drop across a Schottky barrier diode;

FIG. 2 illustrates a simplified circuit diagram of a solar light wherein the voltage of the solar panel of FIG. 1 is different than the voltage of the battery due to voltage drop across the diode;

FIG. 3 illustrates an example of a solar light bulb provided with a solar charge circuit and an improved solar panel that matches a battery, such as the illustrated 3-cells for a NIMH battery;

FIG. 4 illustrates one example of an active solar charge circuit wherein the voltage of the solar panel of FIG. 3 is essentially equivalent to the voltage of the battery;

FIG. 5 illustrates an exploded view of the solar light of FIG. 3;

FIG. 6 illustrates one example of a circuit schematic for a solar light;

FIG. 7 illustrates one example graph of brightness versus time for a solar light;

FIG. 8 illustrates one example of a battery charge curve overlaid on solar cell efficiency bands;

FIG. 9 illustrates one example of a solar light with an improved solar panel;

FIG. 10 illustrates one example of a circuit schematic for a solar light; and,

FIG. 11 illustrates one example of a switch for a solar light with an active solar charge circuit.

### DETAILED DESCRIPTION

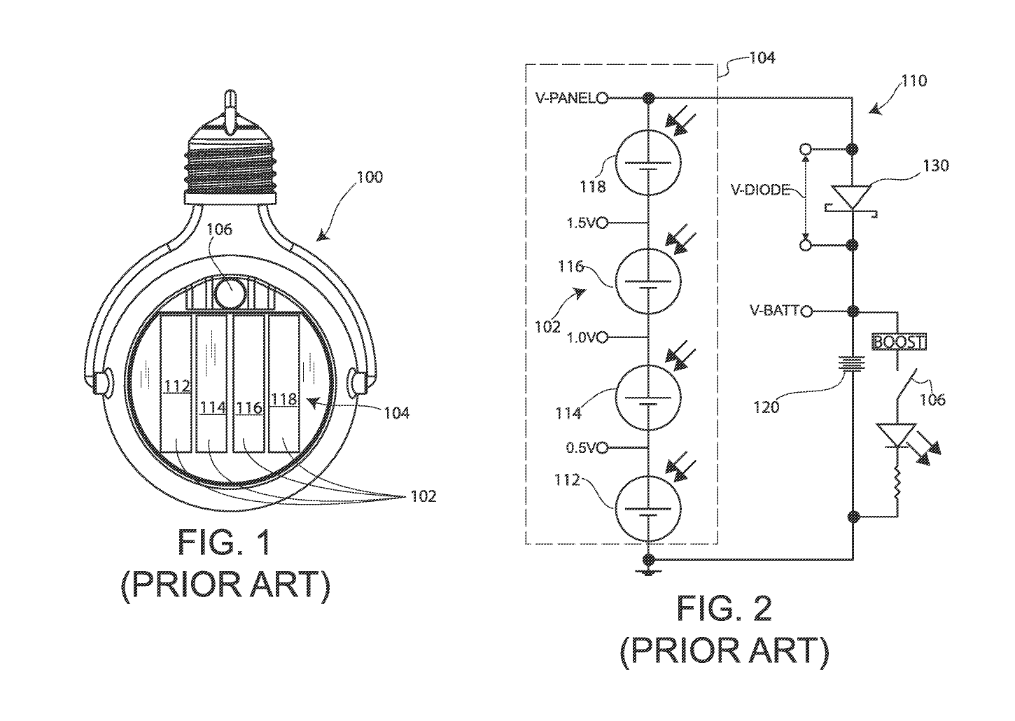

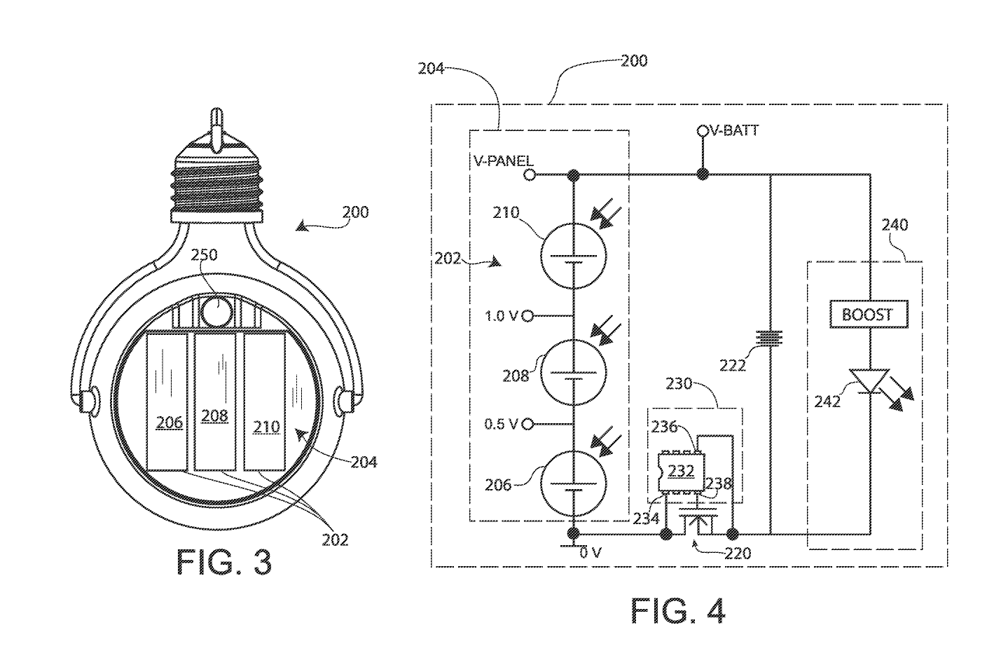

FIG. 3 shows one embodiment of a solar light 200 provided with an active charge circuit. The active solar charge circuit greatly improves system efficiency, so a reduced number of photovoltaic cells 202 can be used in the solar panel 204. In one example, there may be three individual cells 206, 208, 210 in the solar panel 204 producing about 1.5 volts to match the charging voltage of a nickel metal hydride (NiMH) battery. The present solar light 200 (FIG. 3) has an improve efficiency of at least 25 percent over the prior art solar light 100 (FIG. 1).

FIG. 4 shows a simplified circuit diagram of the solar light 200 and is intentionally simplified for descriptive purposes. Later in this description, various embodiments of circuit diagrams will be discussed in detail. With reference to FIG. 4, the solar light 200 is further provided with a switch 220 that is actively controlled. This switch 220 provides a similar benefit to the prior art Schottky barrier diode 130 (FIG. 2) in that power generally flows from the solar panel 204 to a battery 222 when the switch 220 is closed. In a different condition, the switch 220 is open and the solar panel 204 is not connected to the battery 222. The switch 220 can take any of a variety of formats, such as a transistor. If provided as a transistor, it may be a metal-oxide-semiconductor field-effect transistor (MOSFET) semiconductor device used to switch electronic signals.

With continued reference to FIG. 4, the solar light 200 is provided with an active charge circuit 230 used to control the switch 220. The active charge circuit 230 maybe configured with a lot of discrete components, or as illustrated with a microcontroller 232. If configured with a microcontroller 232, various input/output (I/O) pins of the 232 can be used to monitor and control various aspects of the solar light 200. For example, the microcontroller 232 may be provided with a first I/O pin 234 and a second I/O pin 236 configured to read voltage of the solar panel 204 and battery 222, respectively. Microcontroller 232 may be provided with analog-to-digital functionality for converting voltages to digital values ranging from zero to, say, 256; therefore, any non-zero number represents a voltage while zero represents an analog voltage under or equal to zero. The microcontroller 232 is programmed with firmware that takes the input from the pins 234, 236 and determines status of the solar panel 204 and battery 222. If the solar panel 204 is presenting a voltage V-PANEL that is within a predetermined range and above the voltage of the battery 222, V-BATT, then the microcontroller 232 sets out to connect the solar panel 204 directly to the battery 222. In one example, if first pin 234 produces a non-zero number, the solar panel 204 is in sunlight and producing power. One method for connecting the battery 222 to the solar panel 204 is by closing switch 220. If the switch is a MOSFT, an I/O pin 238 of the microcontroller 232 can be turned high to close the switch 220. Power can flow from the solar panel 204 to the battery 222 until the microcontroller 232 determines that the charging process should halt, at which time the I/O pin 238 is turned low and the switch 220 opens.

With continued reference to FIG. 4, the solar light 200 is further provided with a light emitting device 240 that generally contains at least one light emitting diode (LED) 242. The solar light 200 can be activated to produce light via the light emitting diode (LED) 242, for example by depressing an on/off button 250 (FIG. 3). Details of this light production are provided further herein, but the light emitting device 240 may be controlled by the microcontroller 232 or a separate set of components.

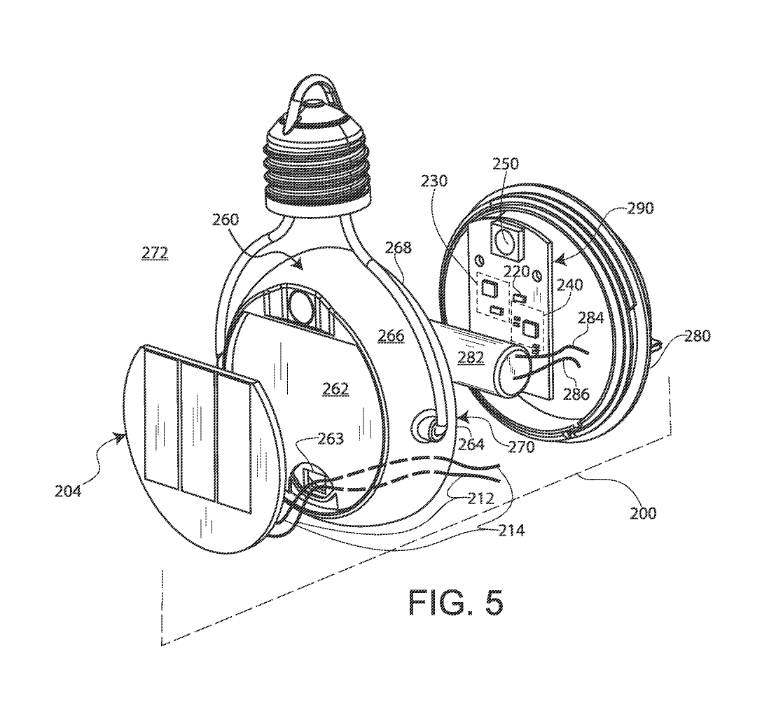

FIG. 5 shows a perspective view of the solar lamp 200 of FIG. 3 in an exploded condition. The solar light 200 is provided with a housing 260 to which various components are attached. Some of these components will be described herein while others are disclosed in a Patent Cooperative Treaty application under the title of ‘Adjustable Solar Charged Lamp’ and International Application No. PCT/US2001/060503 with a priority date of 13 Nov. 2010 which is specifically incorporated by reference for all described and claimed therein. It is to be understood that the housing 260 can take any form and may or may not include provisions for other accessories (e.g. mobile phone charging, multiple light sources, radio, etc.) and that the present description is provided to illustrate the present invention.

With continued reference to FIG. 5, the solar lamp housing 260 has a first side 262 and an oppositely disposed second side 264. As illustrated, the housing 260 also has an exterior edge 266 bridging the span between the first side 262 and the second side 264 generally defining an opening 268 having an interior 270 that is shielded from general ambient conditions referred to herein as an exterior 272. The solar light 200 is further provided with a lens 280 that is generally translucent and threadingly engaged to the housing 260 at the opening 268. Located in the housing interior 270, various components enable the device such as a battery 282 and a circuit board 290. The battery 282 is provided with a positive lead 284 and a negative lead 286 for communicating power to the circuit board 290 via connection such as a connector or simply soldered. The battery 282 may be captured in the interior 270 by the circuit board 290.

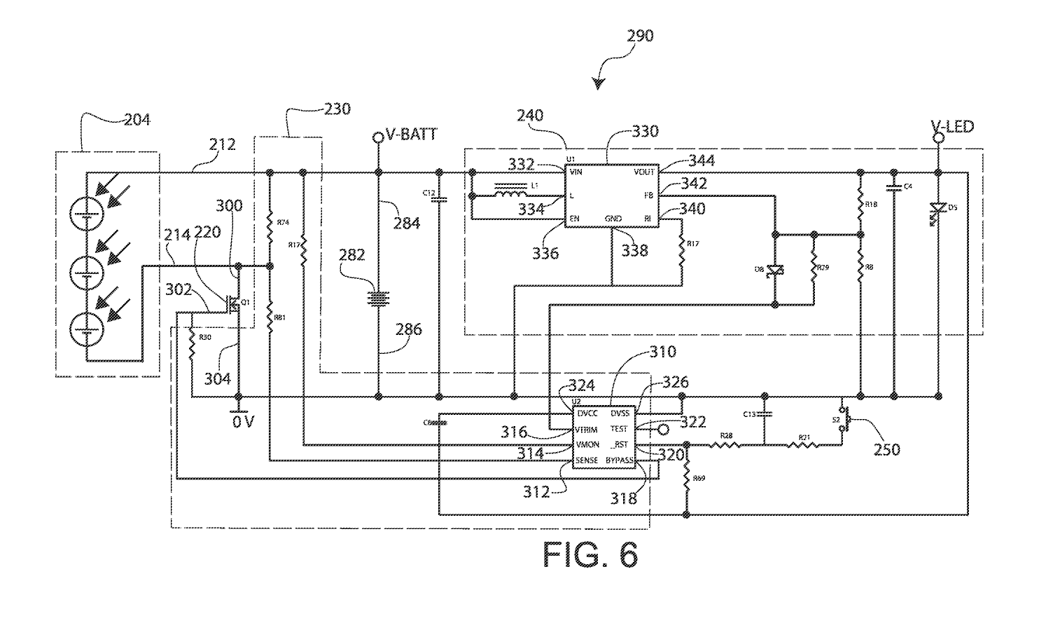

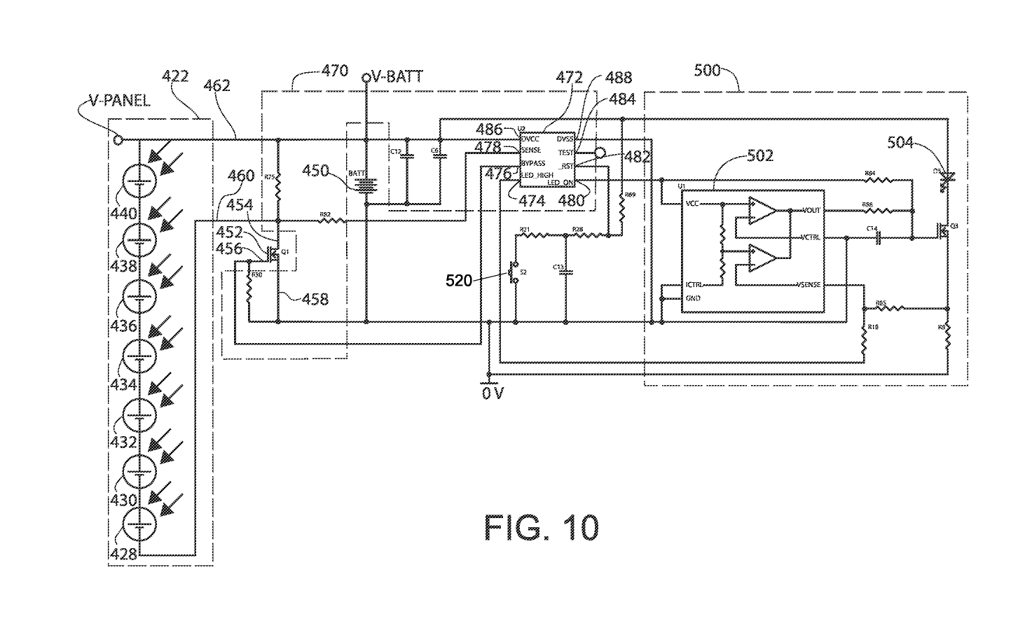

With continued reference to FIG. 5, the circuit board 290 is provided with the solar panel 204, the switch 220, the active charge circuit 230, the light emitting device 240 and the on/off button 250. Specific configurations of the circuit board 290 will described later herein (FIGS. 6 and 10). The solar panel 204 is further provided with a positive terminal 212 and a negative terminal 214. The positive terminal 212 and negative terminal 214 are attached to the solar panel 204 for communicating power from the solar panel 204 to the battery 282 via the circuit board 290. The solar panel 204 may be remote to the solar light housing 260 (e.g. 2 meters away on the roof of a building), or as illustrated attached to the housing first side 262 whereby the terminals 212, 214 pass through a grommet 263 and attach directly (e.g. soldered) to the circuit board 290. The solar panel 204 can be permanently attached to the housing 260 by adhesive (not shown).

FIG. 6 shows simplified circuit diagram of a circuit board 290 for a nickel metal hydride (NiMH) battery 282. At the highest level, the maximum power band of the solar panel 204 matches the operation voltage range of the battery 282 because the switch 220 is actively controlled to ensure that power flows from the solar panel 204 to the battery 282 (and not the opposite). The circuit board 290 is provided with the light emitting device 240 to boost the voltage (e.g. 1.2 volts) of the battery 282 to the required operating voltage of a typical light emitting diode (e.g. 3.1 volts).

With continued reference to FIG. 6, the switch 220 may be any one of a variety of components, however a metal-oxide-semiconductor field-effect transistor (MOSFET) semiconductor device used to switch electronic signals has proven useful. One specific example of this is an N-Channel Enhancement Mode MOSFET made by Diodes Incorporated and sold as Part Number DMN2075U-7. This switch 220 has a drain 300, a gate 302 and a source 304. The drain 300 is attached to the solar panel negative terminal 214 while the source 304 is attached to ground. When a control signal is applied to the gate 302, a connection is made between the drain 300 and the source 304 (also referred to as ‘closed’). When the switch 220 is closed, the solar panel 204 and the battery 282 share ground, therefore electrons can flow between the solar panel 204 and the battery 282.

The active charge circuit 230 is provided with a microcontroller 310, a first resistor R74, a second resistor R81, and a third resistor R17. The microcontroller 310 is provided with a plurality of pins such as a first I/O (Input/Output) pin 312, a second I/O pin 314, a third I/O pin 316, a fourth I/O pin 318, a reset pin 320, a test pin 322, a supply voltage pin 324, and a ground pin 326. The first I/O pin 312 is connected to the second resistor R81 whose distal end is connected to the solar panel negative terminal 214 and one end of the first resistor R74. The opposite end of the first resistor R74 is attached to the solar panel positive terminal 212. The first resistor R74 and second resistor R81 present a signal at the first I/O pin 312 indicative of the solar panel voltage V-PANEL that can be read and processed by the microcontroller 310. One end of the third resistor R17 is attached to the second I/O pin 314 and the distal end is attached to the positive terminal 212 and the positive lead 284 thereby enabling a signal representative of the voltage of the battery V-BATT to be read by the microcontroller 310. The switch gate 302 is attached to the fourth I/O pin 318 of the microcontroller 310. When the microcontroller desires to connect the solar panel 204 to the battery 282, the fourth I/O pin 318 is brought to a predetermined voltage level. The above control of the switch 220 occurs in response to firmware (also referred to as code) programmed and loaded onto the microcontroller 310 via the fourth I/O pin 318.

With continued reference to FIG. 6, the microcontroller 310 is further provided with the light emitting device 240. In the illustrated embodiment, a boost 330 is utilized to increase the relatively low battery voltage V-BATT (say 1.2 volts) to a higher voltage (say 3.2 volts) for operating a light emitting diode and the microcontroller 310. One particularly useful boost 330 is Texas Instrument's Synchronous Boost Converter sold as model number TPS61260. Various components are needed to set and operate the boost 330, therefore the light emitting device 240 may be provided with a couple of capacitors C12, C4, an inductor L1, a Schottky diode D8, a light emitting diode (LED) D5, and a variety of resistors R17, R29, R18, R8. Datasheets for the boost 330 detail properties of the above components, but some specifics will be provided to describe the operation in this particular configuration. The boost 330 is provided with an plurality of pins such as a supply voltage pin 332, an inductor pin 334, an enable input pin 336, a ground pin 338, an output programming pin 340, a voltage feedback pin 342, and a boost converter output 344. The supply voltage pin 332 is connected to the solar panel positive terminal 212 and the battery positive lead 284. The inductor pin 334 is attached to the inductor L1. The enable input pin 336 is attached to the supply voltage pin 332. The ground pin 338 is attached to ground. The output programming pin 340 is attached to ground via the resistor R17. The voltage feedback pin 342 is attached to a network of resistors (e.g. R29, R18, R8), the Schottky diode D8 and most importantly the microcontroller third I/O pin 316 to control the amount of light emitted from the light emitting diode (LED) D5 by sending a pulse width modulated (PWM) signal from the third I/O pin 316. The boost converter output 344 is attached to several discrete components but most notably the light emitting diode (LED) D5 and the microcontroller supply voltage pin 324. The boost converter output 344 is controlled by the resistor R17 across ground and the output programming pin 340 and the signal presented by the third I/O pin 316 and generally noted as the LED voltage V-LED.

With continued reference to FIG. 6, the solar light 200 is controlled by the on/off button 250. The on/off button 250 is a simple momentary interrupt button that cooperates with various components such as a capacitor C13, and resistors R21, R28, R69 to present a signal to the microcontroller reset pin 320.

Having described components of one illustrative embodiment, the process of using the solar light 200 will now be presented. In a daily process, a user places the solar light 200 into direct sunlight positioned so the solar panel 204 receives sunlight throughout the day during a process called charging-condition. Later, the solar light 200 is used during an illumination-condition when the user activates the on/off button 250 to create light via the light emitting diode D5.

During the charging-condition, the battery 282 charges during the day via the sunlight. More specifically, as illustrated in FIG. 6, the solar panel 204 produces a solar panel voltage V-Panel which causes the first I/O pin 312 of the microcontroller 310 to close the switch 220. With the switch 220 closed, a circuit is completed between the solar panel 204 and the battery 282. As long as the solar panel 204 is in sufficient sunlight and the battery 282 is charging, current flows from the solar panel 204 to the battery 282. Later, when the sunlight is removed from the solar panel 204, the voltage at the first I/O pin 312 indicates to the microcontroller 310 to protect the solar panel 204 from current flowing from the battery 282 to the solar panel 204. In one embodiment, the second I/O pin 314 of the microcontroller 310 monitors the battery voltage V-BATT to avoid overcharging the battery 282.

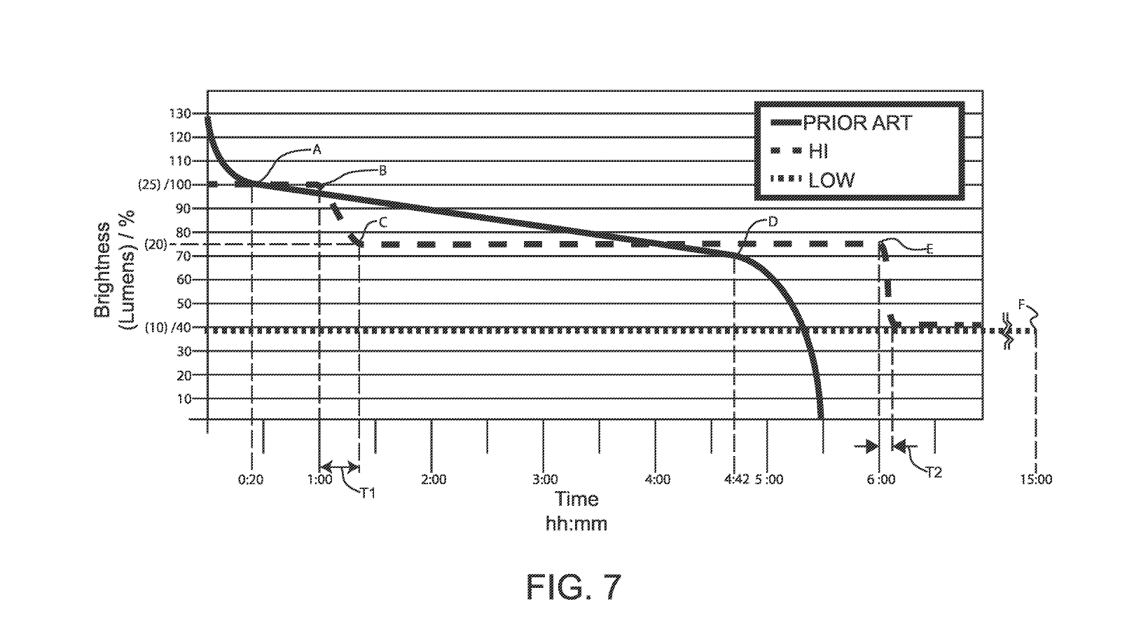

With reference to FIG. 7 showing a graph of brightness versus time for a solar light during the illuminating-condition, the present circuit maintains brightness (measured in lumens) as predetermined by the firmware and components of the circuit. For example, the light emitting device 240 is utilized to boost the battery voltage V-BATT presented to the supply voltage pin 332 up to the voltage needed for the light emitting diode D5, the current is carried from the boost 330 to the light emitting diode D5 via the boost converter output 344. One benefit of this configuration is that the quiescent draw of the boost 330 is relatively low and manageable for long-term storage. Therefore, the microcontroller 310 can be run off of the boost converter output 344 as illustrate. In order to prohibit the illumination of the light emitting diode D5, the light emitting diode voltage V-LED might be limited to 1.8 volts which is lower than the forward voltage of the light emitting diode D5 but enough for basic operation of the microcontroller 310. In order to activate the solar light 200, the user pushes the on/off button 250 which is monitored by the reset pin 320 of the microcontroller 310.

While any configuration can be programed into the microcontroller 310 via the microcontroller test pin 322, the first push of the on/off button 250 usually activates a low-light level illustrated by the short-dashed line in FIG. 7. In this illuminating-condition, the solar light 200 can run for a very long time of, say, 15 hours per solar charged day (defined as 5,000 watt-hours/m̂2-day). If the user activates the on/off button 250 a second time, the solar light 200 is put into a hi-light level illustrated by the long-dashed line in FIG. 7. While the operation of the solar light 200 could be fixed at a single brightness setting, an alternative has been developed and is considered to be part of the present invention. As illustrated by the long dash, the hi-light level brightness of, say, 25 lumens can be maintained for at least 20 minutes and then reduced. In one embodiment, this 25 lumens can be maintained for 1 hour as illustrated by point B. At this point in time, the lumens can drop instantaneously by a fixed percentage or ramped down as illustrated over a time T1 to a mid-light level of, say, 20 lumens (equating to a drop of 20%) ending at point C. The illumination-condition can continue at the mid-light level from point C to point E when a passage of daily run time has been met, such as 6 hours of run time. While the battery 282 may have enough power to continue to run, in many conditions it is better to preserve the energy by dropping from the mid-light level at point E to the low-light level illustrated by the short-dashed line. This drop from the mid-level to low-level light can be instantaneous or over a ramping period best illustrated as T2. The above profile of illuminating-condition maximizes the user experience and meets industry expectations of run time. This illuminating-condition can occur until the battery voltage drops to a predetermined point at which time a recharge is required via the solar panel 204.

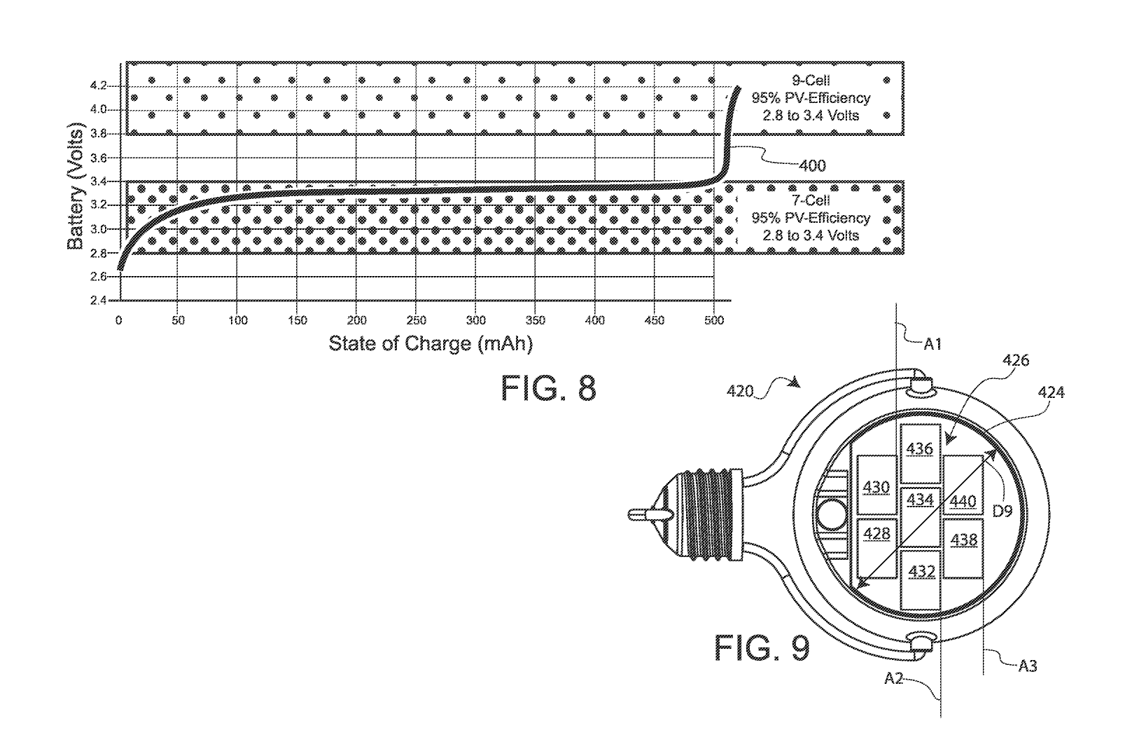

A 3-cell solar panel 204 and a NiMH battery 282 were utilized for descriptive purposes, other embodiments have been contemplated. For example, two emerging battery chemistries are lithium iron phosphate (LiFePO4) and Lithium Ion (Li-ION). Principles described above and claimed herein can be applied to rechargeable lithium batteries as well as future chemistries as deemed commercially viable. With reference to FIG. 8 showing power-bands of two different solar panels and an overlaid battery charge profile, it is useful to match the battery to the solar panel. FIG. 8 was created with actual data of a Lithium Iron Phosphate (LiFePO4) battery as it charged from 2.6 volts to 4.2 volts as represented by LiFePO4 charge profile 400. As illustrated, the vertical axis shows the battery voltage while the horizontal axis shows a state of charge of a battery (e.g. a 550 mAh capacity LiFePO4 battery). It is very useful to keep the battery's state of charge above, say, 100 mAh and below 500 mAh because the voltage of the battery is in a narrow band of 3.2 volts to 3.4 volts. Furthermore, matching properties of the solar panel is possible with narrower bands of voltage. As illustrated, the industry typically uses 9-cell panels for products with LiFePO4 batteries. The 95 percent efficiency band extends from 3.8 to 4.4 volts in standard operating conditions (1000 Watts/meter̂2 at 25 C.). Temperature and irradiation move this band up and down depending on a variety of factors. However, it is clearly shown that a 9-cell solar panel is almost 1 volt above the ideal charging voltage band. Alternatively, a 7-cell solar panel lines up directly on the LiFePO4 charge profile 400. It is possible that an 8-cell solar panel would be useful too, but research showed that the 7-cell was a best solution for the present solar light 200.

FIG. 9 illustrates an alternative embodiment having a unique cell configuration for a LiFePO4 solar light 420. The LiFePO4 solar light 420 is provided with a solar panel 422 having a majority of its perimeter 424 at a constant diameter D9, such as 2.5 inches. After researching various configurations, the highest coverage of 7 individual cells 426 was determined to be as illustrated wherein a first cell 428 and a second cell 430 are adjacent and collinear on first line A1 and additional cells are arranged as further described. The solar panel 422 is further provided with third, fourth, fifth, sixth, and seventh cells 432, 434, 436, 438, 440. The third cell 432, fourth cell 434, and fifth cell 436 are adjacent to each other and collinear on second line A2 that is parallel to the first line A1. The sixth cell 438 and seventh cell 440 are adjacent to each other and collinear to a third line A3 that is parallel to the first and second lines A1, A2. This configuration creates a 2-3-2 arrangement of the individual cells 426 that maximizes photovoltaic cell coverage on the solar panel 422 (for example, but 10% over a traditional equal rows and equal columns such as 1×7 configuration).

FIG. 10 illustrates another alternative embodiment wherein a 7-cell solar panel (e.g. solar panel 422) is used with the LiFePO4 solar light 420. In general, the solar panel 422 is operating at 95% efficiency when the voltage is between 2.8 and 3.4 volts which matches well to a LiFePO4 battery 450 since a switch 452 is utilized to connect the solar panel 422 directly to the LiFePO4 battery 450. The switch 452 may be any one of a variety of components, however a metal-oxide-semiconductor field-effect transistor (MOSFET) semiconductor device used to switch electronic signals has proven useful. One specific example of this is an N-Channel Enhancement Mode MOSFET made by Diodes Incorporated and sold as Part Number DMN2075U-7. This switch 452 has a drain 454, a gate 456 and a source 458. The drain 454 is attached to a negative terminal 460 of the solar panel 422 while the source 458 is attached to ground. When a control signal is applied to the gate 456, a connection is made between the drain 454 and the source 458 (also referred to as ‘closed’). When the switch 452 is closed, the solar panel 422 and the battery 450 share ground, therefore electrons can flow between the solar panel 422 and the battery 450.

The solar panel 422 is provided with an active charge circuit 470 that is provided with a microcontroller 472, a first resistor R75, a second resistor R82, and a third resistor R30. The microcontroller 472 is provided with a plurality of pins such as a first I/O (Input/Output) pin 474, a second I/O pin 476, a third I/O pin 478, a fourth I/O pin 480, a reset pin 482, a test pin 484, a supply voltage pin 486, and a ground pin 488. The third I/O pin 478 is connected to the second resistor R82 whose distal end is connected to the solar panel negative terminal 460 and one end of the first resistor R75. The opposite end of the first resistor R75 is attached to a positive terminal 462 of the solar panel 422. The first resistor R75 and second resistor R82 present a signal at the 476 indicative of the solar panel voltage V-PANEL that can be read and processed by the microcontroller 472. One end of the third resistor R30 is attached to the second I/O pin 476 and the distal end is attached to the ground. When the microcontroller 472 desires to connect the solar panel 422 to the battery 450, the second I/O pin 476 is brought to a predetermined voltage level. The above control of the switch 452 occurs in response to firmware (also referred to as code) programmed and loaded onto the microcontroller 472 via the test pin 484.

With continued reference to FIG. 10, the LiFePO4 solar light 420 is further provided with the light emitting device 500. At the core of the illustrated embodiment, a constant voltage and constant current controller 502 is utilized to monitor and control the current flowing through a light emitting diode (LED) 504. One particularly useful constant voltage and constant current controller 502 is manufactured by Diodes Incorporated and sold under model number AP4312. Various components are needed to set and operate the constant voltage and constant current controller 502, therefore the light emitting device 500 may be provided with a couple of capacitors C14, and a variety of resistors R84, R86, R85, R18, R8. Readily available datasheets for the constant voltage and constant current controller 502 detail properties of the above components and operation of the constant voltage and constant current controller 502.

With continued reference to FIG. 10, the LiFePO4 solar light 420 is controlled by an on/off button 520. The on/off button 520 is a simple momentary interrupt button that cooperates with various components such as a capacitor C13, and resistors R21, R28, R69 to present a signal to the microcontroller reset pin 482. Operation of the present LiFePO4 solar light 420 may be substantially similar to operation of the previously solar light 200.

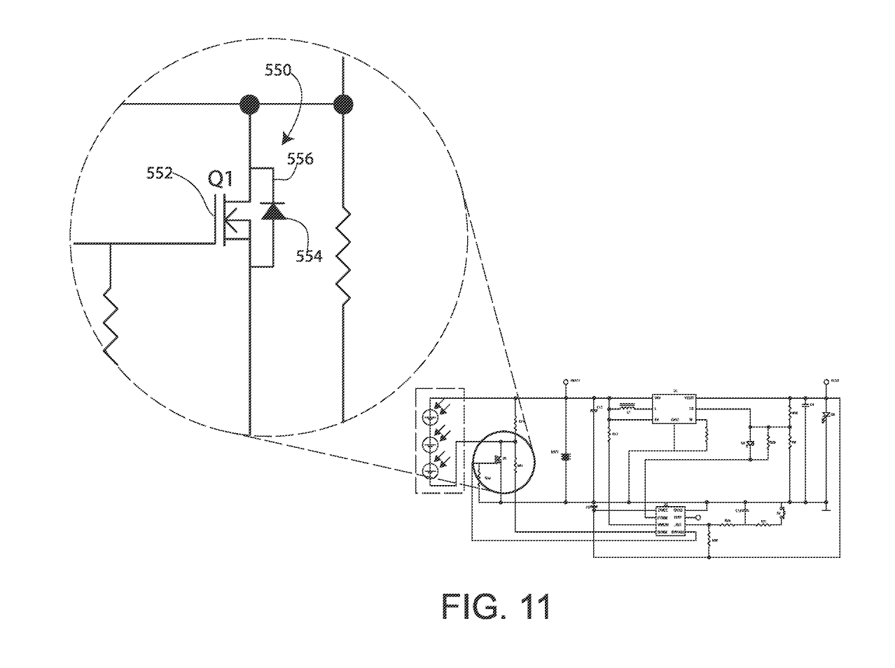

In another alternative embodiment illustrated best in FIG. 11, a solar light similar to the solar light 200, LiFePO4 solar light 420, or other versions covered by the claims can be provided with a switch 550 having a MOSFET transistor 552 and a parallel barrier diode 554. This barrier diode 554 could be a separate component on the circuit board, or integral to the MOSFET transistor 552 such as found in Diode Incorporated's N-Channel enhanced mode MOSFET sold under the model number DMN2075U which has a blocking diode across the drain and the source. Since the parallel barrier diode 554 biases the voltage down, any non-zero digital number in the microcontroller representing the drain 556 of the barrier diode 554 represents that the solar panel is sufficiently exposed to sunlight and capable of charging a battery.

In another alternative embodiment, the a microcontroller is provided with a temperature sense feature that is utilized by firmware to protect the battery. In general, batteries operate best when they are used within a range of temperatures. In this alternative embodiment, the microcontroller may include a feature and firmware to keep the battery from charging or discharging outside of a desired temperature range.

The foregoing description is considered as illustrative of the principles of solar lights. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

What is claimed is:

1. A solar charged device comprising:
a housing defining an interior and an exterior;
a solar panel, defining a solar panel voltage, for generating power connected to said housing exterior, said solar panel comprising a pair of terminals;
a switch located in said housing interior attached to one of said solar panel terminals;
a battery, defining a battery voltage, for storing said power, said battery comprising a pair of leads, one of said battery leads attached to said solar panel and one of said battery leads attached to said switch;
an active charge circuit located in said housing interior operatively connected to said switch and selectively connecting said battery to said solar panel in response to said battery voltage and said solar panel voltage; and,
an electronic device connected to said battery for utilizing said power.

2. The solar charged device of claim 1, wherein said electronic device comprises:
a light emitting device connected to said battery for creating light from said power;
wherein said power communicates: a) from said solar panel to said battery through said switch; and then b) from said battery to said light-emitting device for creating light.

3. The solar charged device of claim 1 wherein said solar panel is attached to said housing exterior.

4. The solar charged device of claim 1 and further comprising:
a first condition and a second condition, wherein:
in said first condition, said solar panel voltage is equal to said battery voltage and said active charge circuit is holding said switch closed; and
in said second condition, said solar panel voltage is below said battery voltage and said switch is open.

5. The solar charged device of claim 1 wherein said switch further comprises:
a metal-oxide-semiconductor field-effect transistor (MOSFET).

6. The solar charged device of claim 5 wherein said switch further comprises:
a barrier diode parallel to said metal-oxide-semiconductor field-effect transistor.

7. The solar charged device of claim 1 wherein said active charge circuit further comprises:
a microcontroller comprising:
a first I/O pin connected to said solar panel voltage; and, a second I/O pin connected to said battery voltage;
a third I/O pin connected to said switch; and,
firmware in said microcontroller that acts on voltages at said first I/O pin and said second I/O pin.

8. The solar charged device of claim 7
wherein said electronic device comprises a light emitting device; and,
wherein said firmware further comprises:
instructions to monitor passage of time with a basic clock system; and,
further instruction to, at a predetermined runtime, reduce light emitting from said light-emitting device to a predetermined percentage.

9. The solar charged device of claim 8 wherein:
said predetermined runtime is at least 20 minutes; and,
wherein said predetermined percentage is at least 70 percent.

10. The solar charged device of claim 8:
wherein said predetermined runtime is at least 20 minutes;
said predetermined percentage is at least 70 percent;
wherein said firmware further comprises:
instructions to, at a second predetermined runtime, reduce light emitting from said light emitting device by a second predetermined percentage; and
wherein said second predetermined runtime is at least 4 hours and said second predetermined percentage is at least 25 percent.

11. A solar charged device comprising:
a housing defining an interior and an exterior;
a solar panel, defining a solar panel voltage, for generating power connected to said housing exterior:
a battery, defining a battery voltage, for storing said power;
a microcontroller comprising:
firmware that acts on a temperature sensor to block power transfer to said battery based on temperature for protecting said battery.

12. A solar charged device comprising:
a housing defining an interior and an exterior;
a solar panel, defining a solar panel voltage, for generating power connected to said housing exterior;
a battery, defining a battery voltage, for storing said power;
a microcontroller comprising:
a basic clock system for tracking passage of time; and, firmware comprising:
instructions to monitor passage of time with said basic clock system; and,
instruction to track runtime of said solar light from inception of said solar light;
a light emitting device, engaged to said battery, for providing light;
a reporting condition wherein a total-time comprises a plurality of sequential idle-off and powered-on conditions of said light emitting device;
wherein said total-time is represented as a series of flashes by said light emitting device; and,
wherein said reporting condition comprises sequential idle-off and powered-on conditions according to the International Morse Code.

13. A solar charged device comprising:
a solar array at a solar array voltage;
a battery, at a battery voltage, electrically coupled to said solar array, said battery having an upper threshold voltage;
a microcontroller connected to said battery;
a light emitting device providing light engaged to said battery, and having an idle-off condition and a powered-on condition;
a first condition wherein said battery voltage is below said battery upper threshold voltage and said light emitting device is in said idle-off condition; and,
a second condition wherein said battery threshold is above said battery upper threshold voltage and said light emitting device is in said powered-on condition.

14. A solar charged device comprising:
a solar panel comprising:
a positive terminal; and,
a ground terminal, defining a panel voltage across said terminals;
an actively controlled charge circuit comprising:
an positive input connected to said solar panel positive terminal;
a ground input connected to said solar panel ground terminal;
a first resistor connected across said positive input and said ground input;
a microcontroller comprising a first input and a second input;
a second resistor connected across said ground input and said microcontroller first input;
a transistor comprising a drain, a gate, and a source;
wherein said transistor drain is connected to said ground input;
wherein said gate is connected to said microcontroller second input;
a third resistor connected across said transistor source and said microcontroller second input;
a positive battery terminal connected to said positive input; and,
a ground battery terminal connected to said transistor source;
wherein said positive input is connected to said positive terminal;
a battery defining a battery voltage, said battery comprising:
a positive lead connected to said actively controlled charge circuit positive battery terminal; and,
a negative lead connected to said actively controlled charge circuit negative battery terminal;
an electronic device comprising:
a positive terminal connected to said battery positive lead;
a ground terminal connected to said battery ground lead; and,
a power utilizing device operatively connected to said device positive and ground terminals;
a first condition wherein said panel voltage is greater than said battery voltage and said transistor connects said solar panel ground terminal to said battery negative lead via said microcontroller second input, thereby transferring energy from said solar panel to said battery; and,
a second condition wherein said panel voltage is less than said battery voltage and said transistor detaches said solar panel ground terminal from said battery negative lead via said microcontroller second input, thereby prohibiting the transfer of energy from said battery to said solar panel.

15. The solar charged device of claim 14 and further comprising:
said lighting emitting circuit further comprises a boost integrated circuit comprising an input voltage and an output voltage that is greater than said battery voltage.

16. A method for charging a battery in a solar light comprising:
providing said solar charged device comprising:
a solar panel having a pair of terminals and defining a solar panel voltage;
a battery having a first terminal and a second terminal, said first terminal connected to said solar panel, said battery defining a battery voltage;
a switch operably associated with said solar panel voltage and said battery voltage, said switch attached between said solar panel and said second terminal of battery;
monitoring said solar panel voltage and said battery voltage;
upon presence of said solar panel voltage, closing said switch; and,
after said closing, charging said battery with said solar panel.

17. The method of claim 16 wherein said providing further comprises:
a microcontroller comprising internal analog-to-digital functionality; and,
wherein said closing upon presence of said solar panel voltage comprises realizing a non-zero digital number representative of a zero or sub-zero solar panel voltage.
